(19) United States
(12) Patent Application Publication
(10) Pub. No.: US 2025/0133040 A1
(43) Pub. Date: Apr. 24, 2025

(54) METHOD AND APPARATUS FOR INSTANT MESSAGING SERVICE

(71) Applicant: KAKAO CORP., Jeju-si (KR)

(72) Inventors: Won Bom HONG, Seongnam-si (KR); Jung Eun PARK, Seongnam-si (KR); Ga Hye JEON, Seongnam-si (KR); Hye Jin JUNG, Seongnam-si (KR); Yi Kyong LIM, Seongnam-si (KR); Ji Sun PARK, Seongnam-si (KR)

(21) Appl. No.: 18/924,665

(22) Filed: Oct. 23, 2024

(30) Foreign Application Priority Data
Oct. 24, 2023 (KR) 10-2023-0143179

(51) Int. Cl. H04L 51/046; G06Q 30/0242

(52) U.S. Cl. CPC H04L 51/046; G06Q 30/0242

(57) ABSTRACT

Disclosed is a method and apparatus for an instant messaging service. An operating method of a server providing an instant messaging service includes generating an access path to a group chatroom linked to a channel. The method includes providing an access point to the group chatroom through a page of the channel based on the access path. The method includes providing information on the channel through the group chatroom. The method includes posting content based on a message transmitted through the group chatroom on the page of the channel.

### CROSS-REFERENCE TO RELATED APPLICATION(S)

This application claims the priority benefit of Korean Patent Application No. 10-2023-0143179 filed on Oct. 24, 2023, in the Korean Intellectual Property Office, the disclosure of which is incorporated herein by reference for all purposes.

### BACKGROUND

### Technical Field

One or more embodiments relate to a method and apparatus for an instant messaging service.

### Description of the Related Art

Recently, with the development of mobile smart devices, the use of an online platform service to communicate with other users via a network has increased. The online platform services for interaction with other users may include, as representative examples, a social networking service (SNS), which is an online platform for generating and consolidating social relationships through communication among users, information sharing, and expansion of personal connections, and an instant messaging service (IMS), which is an online platform for real-time content communication between two or more users. With the increase in communication via mobile devices, the development of technology for online platform services providing not only one-to-one communication with other users but also various forms of communication are required.

### BRIEF SUMMARY

Various embodiments of the present disclosure provide a means for communication and the provision of information through a channel and a chatroom having an interconnection with each other.

However, technical aspects are not limited to the foregoing aspects, and there may be other technical aspects.

According to some embodiments, there is provided an operating method of a server providing an instant messaging service including generating an access path to a group chatroom linked to a channel, providing an access point to the group chatroom through a page of the channel based on the access path, providing information on the channel through the group chatroom, and posting content based on a message transmitted through the group chatroom on the page of the channel.

The providing of the information on the channel through the group chatroom may include posting content linked to the information on the channel, provided through the page of the channel, in the group chatroom.

The posting of the information on the channel in the group chatroom may include at least one of transmitting a message including the information on the channel through the group chatroom and posting content corresponding to the information on the channel in a predetermined area in the group chatroom.

The posting of the content on the page of the channel may include generating content corresponding to the message based on relevance between the message transmitted through the group chatroom and the channel and posting the generated content on the page of the channel.

The operating method of the server may further include determining a participation condition of a user account having requested participation in the group chatroom through the access point based on a participation condition set for the group chatroom and including the user account as a participant in the group chatroom based on a result of determining the participation condition.

The operating method of the server may further include providing an access point to the channel through the group chatroom.

According to some embodiments, there is provided an operating method of a server providing an instant messaging service including providing a first advertising material to a terminal of a first user group through a first advertising channel included in a group chatroom linked to a channel, providing a second advertising material to a terminal of a second user group through the first advertising channel, and determining an advertising material to be provided through a second advertising channel linked to the server based on advertisement performance corresponding to the first advertising material and advertisement performance corresponding to the second advertising material.

The determining of the advertising material to be provided through the second advertising channel may include determining an advertising material determined to have higher advertisement performance between the first advertising material and the second advertising material as the advertising material to be provided through the second advertising channel.

The advertisement performance corresponding to the first advertising material and the advertisement performance corresponding to the second advertising material may be determined based on an a/b test corresponding to the first advertising material and the second advertising material.

An advertisement type corresponding to the first advertising channel may be the same as an advertisement type corresponding to the second advertising channel.

According to some embodiments, there is provided an operating method of a terminal using an instant messaging service including displaying information on a group chatroom linked to a channel through a page of the channel, requesting participation in the group chatroom based on the information on the group chatroom, and displaying a page of the group chatroom based on approval of the request.

The displaying of the page of the group chatroom may include outputting an advertising material corresponding to the channel through the page of the group chatroom and executing an action corresponding to the advertising material.

According to some embodiments, there is provided a server providing an instant messaging service including a processor configured to generate an access path to a group chatroom linked to a channel, provide an access point to the group chatroom through a page of the channel based on the access path, provide information on the channel through the group chatroom, and post content based on a message transmitted through the group chatroom on the page of the channel.

The processor may provide information on the channel through the group chatroom and may post content linked to the information on the channel, provided through the page of the channel, on the group chatroom.

The processor may provide information on the channel through the group chatroom, may transmit a message including the information on the channel through the group chatroom, and may post content corresponding to the information on the channel in a predetermined area in the group chatroom.

The processor, when posting the content on the page of the channel, may generate content corresponding to the message based on relevance between the message transmitted through the group chatroom and the channel and may post the generated content on the page of the channel.

The processor may determine a participation condition of a user account having requested participation in the group chatroom through the access point based on a participation condition set for the group chatroom and may include the user account as a participant in the group chatroom based on a result of determining the participation condition.

According to some embodiments, there is provided a terminal using an instant messaging service including a processor configured to display information on a group chatroom linked to a channel through a page of the channel, request participation in the group chatroom based on the information on the group chatroom, and display a page of the group chatroom based on approval of the request.

According to some embodiments, there is provided a terminal using an instant messaging service including a processor configured to display information on a group chatroom linked to a channel through a page of the channel, request participation in the group chatroom based on the information on the group chatroom, and display a page of the group chatroom based on approval of the request.

### BRIEF DESCRIPTION OF THE SEVERAL VIEWS OF THE DRAWINGS

FIG. 1 is a diagram illustrating a system for an instant messaging service according to an embodiment.

FIG. 2 is a flowchart illustrating an operation of a server providing the instant messaging service according to an embodiment.

FIG. 3 is another flowchart illustrating an operation of a server providing the instant messaging service according to an embodiment.

FIG. 4 is a flowchart illustrating an operation of a terminal using the instant messaging service according to an embodiment.

FIGS. 5A to 5D are diagrams each illustrating a screen of a terminal displaying a page of a channel.

FIGS. 6A and 6B are diagrams each illustrating content posted on a page of a channel based on a message of a group chatroom, according to an embodiment.

FIGS. 7A and 7B are other diagrams each illustrating content posted on a page of a channel based on a message of a group chatroom, according to an embodiment.

FIGS. 8A and 8B are other diagrams each illustrating content posted on a page of a channel based on a message of a group chatroom, according to an embodiment.

FIGS. 9A and 9B are other diagrams each illustrating content posted on a page of a channel based on a message of a group chatroom, according to an embodiment.

FIG. 10 is a diagram illustrating a screen of a terminal displaying a page of a group chatroom, according to an embodiment.

FIGS. 11A and 11B are diagrams each illustrating content posted on a page of a group chatroom based on information included on a page of a channel, according to an embodiment.

FIGS. 12A and 12B are other diagrams each illustrating content posted on a page of a group chatroom based on information included on a page of a channel, according to an embodiment.

FIGS. 13A and 13B are diagrams each illustrating a participation condition of a group chatroom, according to an embodiment.

FIGS. 14A and 14B are other diagrams each illustrating a participation condition of a group chatroom, according to an embodiment.

FIGS. 15A and 15B are diagrams illustrating a page of a group chatroom including advertising materials provided differently to each user, according to an embodiment.

FIG. 16 is another diagram illustrating a hardware configuration of a system for the instant messaging service according to an embodiment.

### DETAILED DESCRIPTION

The following detailed structural or functional description is provided as an example only and various alterations and modifications may be made to embodiments. Here, examples are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/including” and/or “includes/including” when used herein, specify the presence of stated features, integers, steps, operations, elements, and/or components, but do not preclude the presence or addition of one or more other features, integers, steps, operations, elements, components and/or groups thereof.

The text “at least one of A and B” as used herein should be understood to include at least one of A, or at least one of B, or at least one of both A and B. This similarly applies to “at least one of A, B, and C” and so forth.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art and are not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like elements and a repeated description related thereto will be omitted.

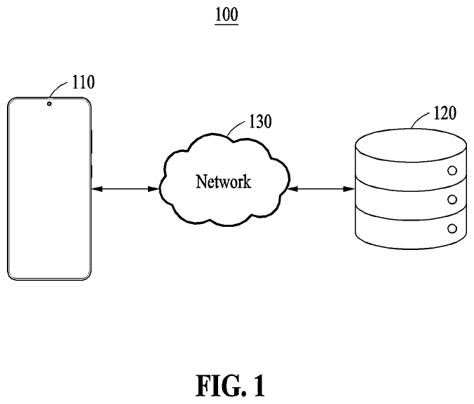

FIG. 1 is a diagram illustrating a system for an instant messaging service according to an embodiment.

Referring to FIG. 1, a system 100 for the instant messaging service according to an embodiment may include a terminal 110, a server 120, and a network 130. The detailed hardware configurations of the server 120 and the terminal 110 are described below.

The server 120 may include a server providing the instant messaging service through the network 130. The instant messaging service may include a service allowing a plurality of users to chat in real time by transmitting text messages, voice messages, media files, and other instant messages through the network 130, such as wireless Internet or a wireless communication network, and services related thereto. For example, the server 120 may include a server providing the instant messaging service for a channel and a group chatroom linked to the channel. The instant messaging service for the channel and the group chatroom linked to the channel is described below.

The server 120 may be linked with a web for the instant messaging service or an application (hereinafter, the app) for the instant messaging service executed by the terminal 110 to provide a user interface (UI), a function, an operation, or a service. Hereinafter, the web for the instant messaging service or the app for the instant messaging service may be referred to as an instant messenger.

The terminal 110 may be one of electronic apparatuses, such as a computer, a portable computer, a wireless phone, a mobile phone, a smartphone, a personalized digital assistant (PDA), a web tablet, and a wearable device, and may refer to any apparatus that may install and execute an app or may execute a web. In this case, the terminal 110 may be provided with services and/or content through an app or a web. For example, through the control of an app or a web, the terminal 110 may perform overall service operations, such as service screen setting, data input, data transmission and reception, and data storage. For example, the terminal 110 may process a user interface or user interaction through a processor and may output a processing result through an output device of the terminal 110 or transmit the processing result.

An instant messenger provided by the server 120 may drive the terminal 110. A user may use the instant messaging service provided by the server 120 by executing the instant messenger in the terminal 110. The user may generate a user account by subscribing to the instant messaging service through the instant messenger. The user may use the instant messaging service through the terminal 110 of the user account subscribing to the instant messaging service. The terminal 110 of the user account may be a terminal logging in with the user account generated by subscribing to the instant messaging service.

According to an embodiment, a chat interface may be provided to the terminal 110 through the app for the messaging service. The chat interface may be an interface for a message transmission/reception function provided by the messaging service and may include, for example, an interface that provides a function of transmitting messages through a chatroom, in which at least one user account participates, and displays received messages. The chat interface may correspond to a chatroom which is a virtual space in which at least one user account participates and a chat between users takes place.

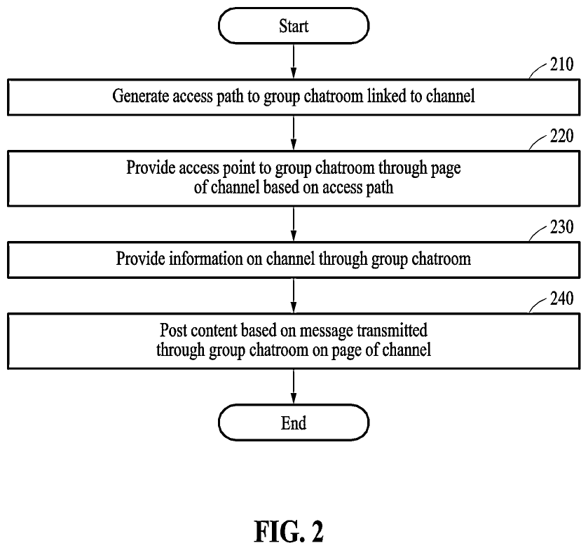

FIG. 2 is a flowchart illustrating an operation of a server providing the instant messaging service according to an embodiment.

The server providing the instant messaging service may correspond to the server 120 described above with reference to FIG. 1. Hereinafter, the server providing the instant messaging service may be briefly referred to as the server.

Referring to FIG. 2, an operating method of the server, according to an embodiment, may include operation 210 of generating an access path to a group chatroom linked to a channel.

An instant messaging server according to an embodiment may provide various types of accounts, including personal accounts, corporate accounts, or service accounts, for the use of the instant messaging service. The personal accounts may be accounts for general users, the corporate accounts may be accounts for specific companies, and the service accounts may be accounts for specific services. The corporate accounts or the service accounts may be referred to as channels.

The group chatroom may be a chatroom in which a channel and one or more user accounts may participate. For example, the group chatroom may be a type of chatroom (e.g., an anonymous chatroom) in which the channel and the one or more user accounts may participate through an access path to the chatroom. The access path to the chatroom may include information, like an address or a link, to access or participate in the chatroom. The access path to the group chatroom may be shared through various media (e.g., webpages, text messages, instant messages, emails, etc.) including posting spaces. A user who receives the access path may participate in the group chatroom through a user account subscribing to the instant messaging service.

The user who participates in the group chatroom may participate in the group chatroom with their real-name profile or anonymous profile corresponding to the user account. The real-name profile is a profile including verified real-name information and may include at least one of, for example, name, age, gender, phone number, email address, job information, or residence information, verified as the personal information of the user, and a photo set by the user. The anonymous profile may include information, like an arbitrarily generated name (or nickname) and/or a random photo, which is not verified as real information and is set arbitrarily by the user.

A profile used to participate in the group chatroom may be determined by the user's choice or the settings of the group chatroom. For example, when the type of profile used to participate in the group chatroom is not set, whether to participate in the group chatroom with a real-name profile or an anonymous profile may be determined by the user. For example, when the type of profile used to participate in the group chatroom is set to a real-name profile, the user may participate in the group chatroom with a real-name profile. For example, when the type of profile used to participate in the group chatroom is set to an anonymous profile, the user may participate in the group chatroom with an anonymous profile.

The group chatroom linked to a channel, according to an embodiment, is managed and/or operated by the channel, includes an access point on a page of the channel, provides information on the channel, and may be, for example, an ‘open chatroom’ officially operated by the channel or an official chatroom corresponding to the channel. In the drawings, the group chatroom linked to the channel may be expressed as ‘official open chat,’ ‘official open chatroom,’ ‘open chat,’ or ‘open chatroom.’ The ‘open chat’ or ‘open chatroom’ is a registered trademark of Kakao Corporation. Hereinafter, the group chatroom linked to the channel may be briefly referred to as the group chatroom.

The operating method of the server, according to an embodiment, may include an operation of determining a participation condition of a user account having requested participation in the group chatroom through the access point based on a participation condition set for the group chatroom and an operation of including the user account as a participant in the group chatroom based on the result of determining the participation condition. For example, the participation condition may include at least one of the registering of the channel linked to the group chatroom as a certain relationship (e.g., friend) and the signing up for a membership (e.g., paid membership) corresponding to the channel.

When the registering of the channel linked to the group chatroom as a certain relationship is set as the participation condition for the group chatroom, the server may determine whether the user account requesting participation in the group chatroom is an account having registered the channel as the certain relationship and may allow the participation of the user account in the group chatroom. When the user account requesting participation in the group chatroom is an account having registered the channel as the certain relationship, the server may allow the participation of the user account in the group chatroom. When the user account requesting participation in the group chatroom is an account having not registered the channel as the certain relationship, the server may transmit a message notifying the participation condition to the terminal of the user account or may request the registering of the channel as the certain relationship.

When the signing up for a membership corresponding to the channel linked to the group chatroom is set as the participation condition for the group chatroom, the server may determine whether the user account requesting participation in the group chatroom is an account having signed up for the membership corresponding to the channel and may allow the participation of the user account in the group chatroom. When the user account requesting participation in the group chatroom is an account having signed up for the membership corresponding to the channel, the server may allow the participation of the user account in the group chatroom. When the user account requesting participation in the group chatroom is an account having not signed up for the membership corresponding to the channel, the server may transmit a message notifying the participation condition to the terminal of the user account or may request the signed up for the membership corresponding to the channel.

The operating method of the server, according to an embodiment, may include operation 220 of providing an access point to the group chatroom through the page of the channel based on the access path. The page of the channel may include a page including the information on the channel and/or a chatroom page of the channel.

The page including the information on the channel may be a page including at least one of a profile (e.g., name, ID, nickname, photo, introduction, etc.) of the channel, information on an account having registered the channel as a certain relationship, advertisement information corresponding to the channel, information on a product corresponding to the channel, information on a service corresponding to the channel, and a service page corresponding to the channel.

The chatroom page of the channel is a page displaying a chat interface or a chatroom between the channel and a user account. The chatroom between the channel and a user account is distinguished from the group chatroom and may be a 1:1 chatroom between the channel and the user account.

The access point to the group chatroom is an interfacing object where a function (or functionality) connecting to the group chatroom is linked to the channel and may include the access path to the group chatroom. For example, the access point to the group chatroom may include a message including the interfacing object (e.g., a button) included on the page of the channel, content corresponding to a message of the group chatroom, and the access path to the group chatroom transmitted through the chatroom between the channel and the user account.

The terminal of the user account may access the group chatroom linked to the channel through the access point to the group chatroom included on the page of the channel or may transmit the request for participation in the group chatroom to the server. For example, the terminal of the user account may access the group chatroom through the input of selecting the interfacing object connecting to the group chatroom included on the page of the channel or may transmit the request for participation in the group chatroom to the server.

The operating method of the server, according to an embodiment, may include an operation of providing an access point to the channel through the group chatroom. In other words, the access point connecting to the page of the channel may be provided to the chat interface corresponding to the group chatroom. The page of the channel includes the access point connecting to the group chatroom, and the group chatroom includes the access point connecting to the page of the channel. Thus, switching may be performed between the page of the channel and the group chatroom.

The operating method of the server, according to an embodiment, may include operation 230 of providing the information on the channel through the group chatroom.

According to an embodiment, operation 230 of providing the information on the channel through the group chatroom may include an operation of providing content linked to the information on the channel included on the page of the channel through the group chatroom.

For example, operation 230 of providing the information on the channel through the group chatroom may include an operation of transmitting a message including the information on the channel through the group chatroom. The information on the channel provided through the page of the channel may be provided in message form through the group chatroom to the terminal of a user account participating in the group chatroom.

For example, operation 230 of providing the information on the channel through the group chatroom may include an operation of posting content corresponding to the information on the channel in a predetermined area (e.g., an upper end of the chatroom, etc.) in the group chatroom. For example, the advertising content of the channel, posted on the page of the channel, may be posted in a banner advertisement area included in the group chatroom.

According to an embodiment, pieces of content posted in the group chatroom may be differently determined depending on each user account participating in the group chatroom. For example, depending on user groups, different advertisements may be provided through the group chatroom. A first advertising material may be output through a predetermined area of the group chatroom to the terminal of a user account corresponding to a first user group. A second advertising material may be output through a predetermined area of the group chatroom to the terminal of a user account corresponding to a second user group. The operation of the server providing different advertisements depending on the user groups through the group chatroom is described in detail below.

The operating method of the server, according to an embodiment, may include operation 240 of posting content based on messages transmitted through the group chatroom on the page of the channel. The content posted on the page of the channel may be generated based on the messages transmitted through the group chatroom. For example, the content posted on the page of the channel may include text and/or files (e.g., images, videos, audio, document files, etc.) included in the messages transmitted through the group chatroom. For example, the content posted on the page of the channel may include a list of one or more messages transmitted through the group chatroom. For example, the content posted on the page of the channel may be generated by adding another content form (e.g., text, images, etc.) to the messages transmitted through the group chatroom.

According to an embodiment, operation 240 of posting the content on the page of the channel may include an operation of generating content corresponding to the messages based on relevance between the messages transmitted through the group chatroom and the channel and an operation of posting the generated content on the page of the channel.

For example, the relevance between the messages and the channel may be determined based on reactions to the messages. The reactions to the messages are reactions to messages of participants in the group chatroom and may include actions, for example, the viewing of, sharing of, copying of, replying to, and/or reacting (e.g., liking, bookmarking, etc.) to the messages. As the number of reactions to a message is greater, the relevance between the message and the channel is determined to be a higher value.

For example, the relevance between a message and the channel may be determined based on whether the message includes the information on the channel. For example, when the message includes the profile information (e.g., name, ID, nickname, photo, introduction, etc.) of the channel, the relevance between the message and the channel may be determined to be a higher value compared to a message not including such information. For example, when the message includes information (e.g., the name of a product, a purchase link of the product, a review of the product, etc.) on the product corresponding to the channel, the relevance between the message and the channel may be determined to be a higher value compared to a message not including such information. For example, when the message includes information (e.g., the name of a service, a purchase link of the service, a review of the service, etc.) on the service corresponding to the channel, the relevance between the message and the channel may be determined to be a higher value compared to a message not including such information.

The server may generate content to be posted on the page of the channel, based on one or more messages determined to have a high relevance with the channel among the messages transmitted through the group chatroom.

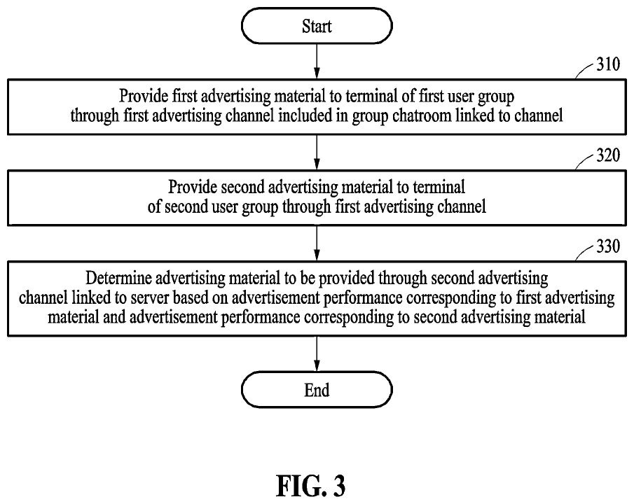

FIG. 3 is another flowchart illustrating an operation of a server providing the instant messaging service according to an embodiment.

The server providing the instant messaging service may correspond to the server 120 described above with reference to FIG. 1. Hereinafter, the server providing the instant messaging service may be briefly referred to as the server.

Referring to FIG. 3, an operating method of the server, according to an embodiment, may include operation 310 of providing a first advertising material to a terminal of a first user group through a first advertising channel included in a group chatroom linked to a channel, operation 320 of providing a second advertising material to a terminal of a second user group through the first advertising channel, and operation 330 of determining an advertising material to be provided through a second advertising channel linked to the server based on advertisement performance corresponding to the first advertising material and advertisement performance corresponding to the second advertising material.

The group chatroom may include the first advertising channel providing an advertisement corresponding to the linked channel. An advertising channel is a medium through which an advertising material is output and may include, for example, a chatroom and a page of a web or an app. Specific advertising material may be output to the first advertising channel, and the advertising material may be output through the first advertising channel to the terminal of a user account having accessed the group chatroom.

The advertising material output to the first advertising channel may be determined for each user account. The first advertising material may be provided through the first advertising channel to the terminal of a user account corresponding to the first user group. The second advertising material may be provided through the first advertising channel to the terminal of a user account corresponding to the second user group. At least some of the content (e.g., text, images, etc.) included in the first advertising material and the second advertising material may be different. Even if the first advertising material and the second advertising material are advertising materials to advertise the same object (e.g., a product, a service, or a brand), at least some of the included content (e.g., the text, the images, etc.) may be different.

According to an embodiment, operation 330 of determining the advertising material to be provided through the second advertising channel may include determining an advertising material determined to have higher advertisement performance between the first advertising material and the second advertising material as the advertising material to be provided through the second advertising channel. An advertisement type corresponding to the first advertising channel may be the same as an advertisement type corresponding to the second advertising channel. For example, when the advertisement type corresponding to the first advertising channel is a banner advertisement, the advertisement type corresponding to the second advertising channel may also be a banner advertisement.

The advertisement performance may be determined by a user's action in response to an advertisement provided to the terminal of the user account. For example, the user's action may include at least one of the clicking of the advertisement, a purchase of an advertisement target product, a visit to an advertisement target page, and the subscribing to an advertisement target service. When the number of clicks on the first advertising material is greater than the number of clicks on the second advertising material, the advertisement performance of the first advertising material may be determined to be higher than the advertisement performance of the second advertising material. When the number of conversions (e.g., views, purchases, signups, event participation, etc.) of a user having entered a page of an advertiser through the clicking of the first advertising material is greater than the number of conversions of a user having entered a page of an advertiser through the clicking of the second advertising material, the advertisement performance of the first advertising material is higher than the advertisement performance of the second advertising material.

For example, the advertisement performance corresponding to the first advertising material and the advertisement performance corresponding to the second advertising material may be determined based on an a/b test corresponding to the first advertising material and the second advertising material. The a/b test may correspond to a test for determining content in which a viewer of the content or a receiver of the convent shows greater interest by comparing two pieces of content. The group chatroom linked to the channel may be used as a medium for the a/b test of advertising materials corresponding to the channel. By providing different advertising materials to each user group, the advertisement performance of the advertising materials may be evaluated. The evaluation of the advertisement performance of the advertising materials may be used to establish an advertising strategy, like the adjusting of a ratio of the advertising materials provided as advertisements or the determining of an advertising material to be provided through another advertising channel.

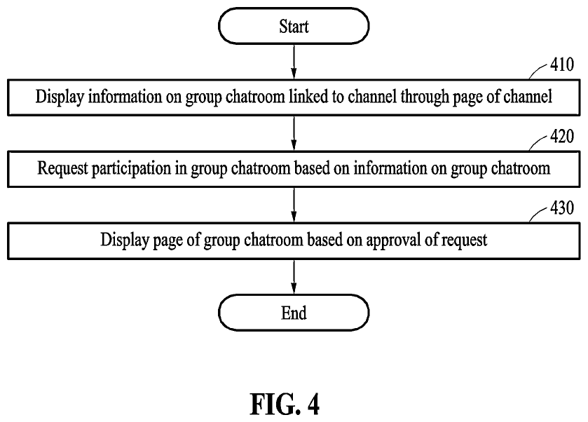

FIG. 4 is a flowchart illustrating an operation of a terminal using the instant messaging service according to an embodiment.

The terminal using the instant messaging service may correspond to the terminal 110 described above with reference to FIG. 1. Hereinafter, the terminal using the instant messaging service may be briefly referred to as the terminal.

Referring to FIG. 4, an operating method of the terminal using the instant messaging service may include operation 410 of displaying information on a group chatroom linked to a channel through a page of the channel and operation 420 of requesting participation in the group chatroom based on the information on the group chatroom.

The information on the group chatroom displayed through the page of the channel may include at least one of an access path to the group chatroom to access the group chatroom and content based on messages transmitted through the group chatroom. The terminal may request participation in the group chatroom based on the information on the group chatroom. The information on the group chatroom displayed through the page of the channel may be an access point to the group chatroom.

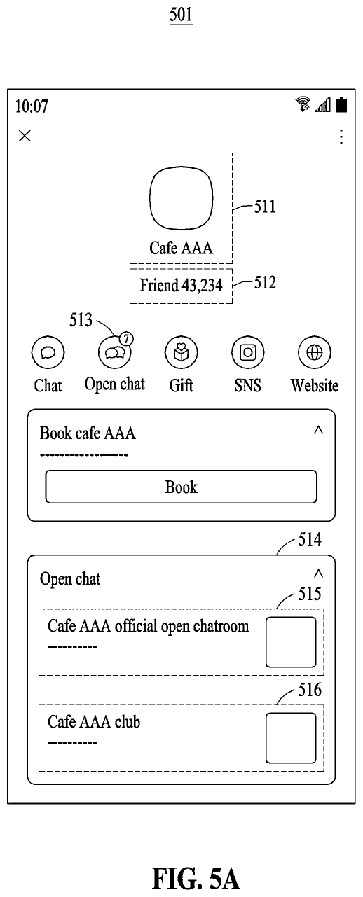

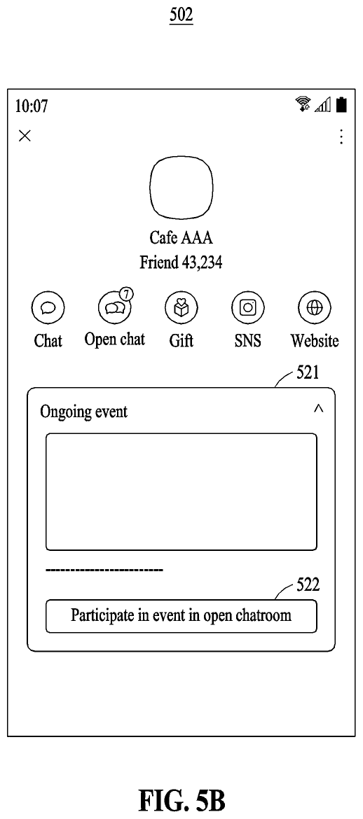

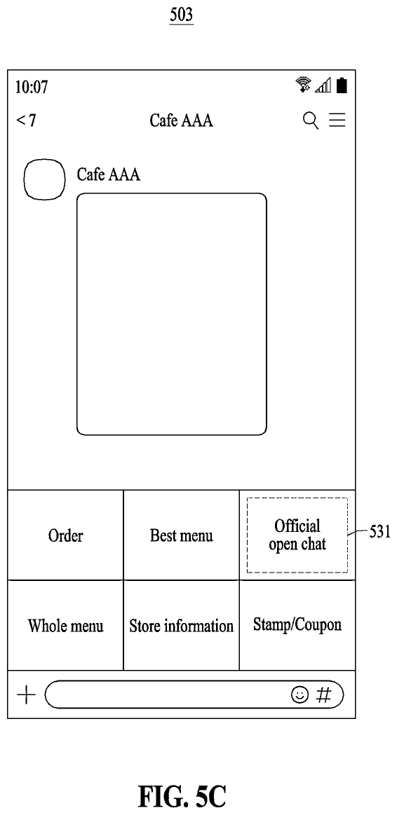

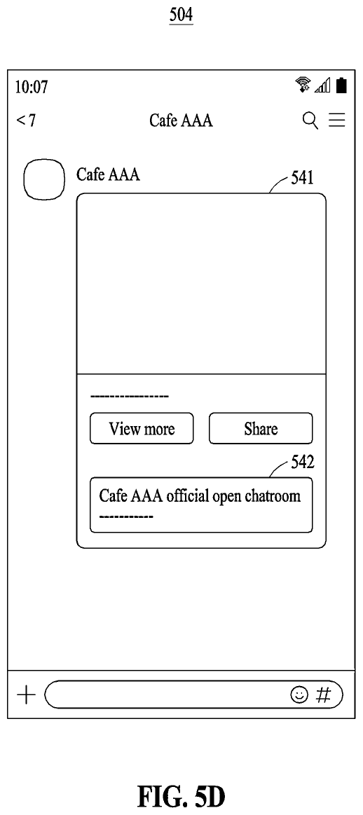

For example, FIGS. 5A and 5B are examples of screens of the terminal displaying the page of the channel. Screens 501, 502, 503, and 504 of FIGS. 5A to 5D may be displayed on the terminal requesting the page of the channel through the instant messaging service. The screens 501 and 502 of FIGS. 5A and 5B may be pages including information on the channel. The screens 503 and 504 of FIGS. 5C and 5D may be chatroom pages of the channel.

Referring to the screen 501 of FIG. 5A, the page of the channel may be a page including the information on the channel. The page of the channel may include the information, like the profile information 511 of the channel and the number 512 of accounts registering the channel as a certain relationship, on the channel.

The page of the channel may include an interfacing object 513 to request the group chatroom linked to the channel. The interfacing object 513 may be an example of the access point connecting to the group chatroom. Through an input of selecting the interfacing object 513, the terminal may request participation in the group chatroom from the server. When the request is approved, the terminal may participate in (or access) the group chatroom and the screen 501 of the terminal may be switched to a screen displaying a page of the group chatroom linked to the channel.

The page of the channel may include a list 514 of chatrooms related to the channel. The list 514 of chatrooms may include a list of the types of chatrooms in which participation is possible through the access path. The list 514 of chatrooms may include an item 515 of group chatrooms linked to the channel. The list 514 of chatrooms may also include an item 516 of a chatroom determined to be related to a channel generated by a user account other than the item 515 of the group chatrooms linked to the channel. The item 516 of a chatroom determined to be related to a channel may include an item of the chatroom including information, like at least one of the name, introduction, tag, and theme of the chatroom, related to the channel.

The item 515 of the group chatrooms may be an example of the access point connecting to the group chatrooms. Through an input of selecting the item 515 of the group chatrooms, the terminal may request participation in the group chatrooms from the server. When the request is approved, the terminal may participate in (or access) the group chatroom and the screen 501 of the terminal may be switched to a screen displaying a page of the group chatroom linked to the channel.

Referring to the screen 502 of FIG. 5B, the page of the channel may be a page including the information on the channel. The page of the channel may include event information 521 related to the channel. An event related to the channel may include an event held by using the group chatroom related to the channel. The event information 521 may be an example of the access point connecting to the group chatroom. Through an input of selecting an interfacing object 522 to request the group chatroom included in the event information 521, the terminal may request participation in the group chatroom from the server. When the request is approved, the terminal may participate in (or access) the group chatroom and the screen 502 of the terminal may be switched to a screen displaying the page of the group chatroom linked to the channel.

Referring to the screen 503 of FIG. 5C, the page of the channel may include a chatroom page of the channel. As described above, the chatroom page of the channel is a page displaying a chat interface or a chatroom between the channel and a user account. The chatroom between the channel and a user account is distinguished from the group chatroom linked to the channel and may be a 1:1 chatroom between the channel and the user account.

The page of the channel may include an interfacing object 531 to request the group chatroom linked to the channel. The interfacing object 531 may be an example of the access point connecting to the group chatroom. Through an input of selecting the interfacing object 531, the terminal may request participation in the group chatroom from the server. When the request is approved, the terminal may participate in (or access) the group chatroom and the screen 503 of the terminal may be switched to a screen displaying the page of the group chatroom linked to the channel.

Referring to the screen 504 of FIG. 5D, the page of the channel may include a chatroom page of the channel. The page of the channel may include a message 541 transmitted through a chatroom of the channel. For example, the message 541 may include an informative and/or promotional message transmitted in the channel with a user account as a recipient.

The message 541 may include an interfacing object 542 to request the group chatroom linked to the channel. The interfacing object 542 may be an example of the access point connecting to the group chatroom. Through an input of selecting the interfacing object 542, the terminal may request participation in the group chatroom from the server. When the request is approved, the terminal may participate in (or access) the group chatroom and the screen 504 of the terminal may be switched to a screen displaying the page of the group chatroom linked to the channel.

According to an embodiment, the information on the group chatroom displayed through the page of the channel may include content based on messages transmitted through the group chatroom. The page of the channel may include content based on messages transmitted through the group chatroom linked to the channel.

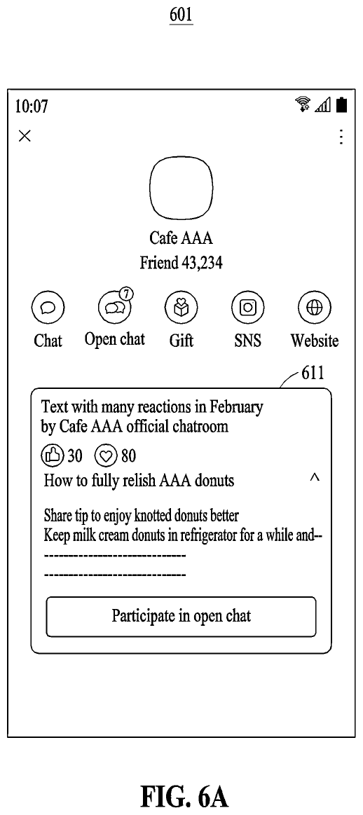

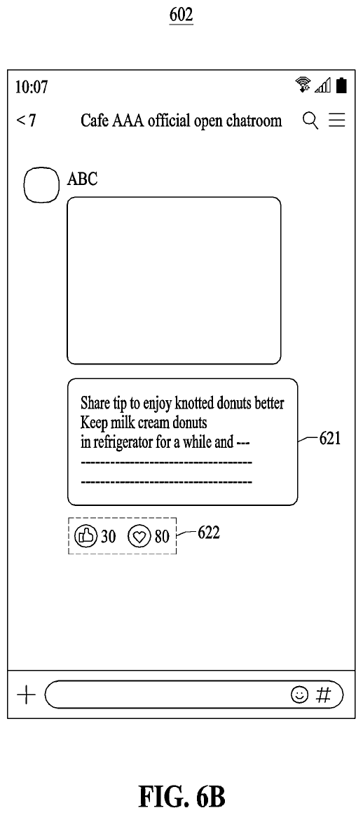

For example, a screen 601 of FIG. 6A may be a screen of the terminal displaying the page of the channel. Referring to the screen 601 of FIG. 6A, the page of the channel may include content 611 corresponding to the messages transmitted through the group chatroom. The content 611 may include the content of a message with a significant number of reactions to the message among the messages transmitted through the group chatroom. For example, the content 611 may include the text of a message 621 with a significant number of reactions to the message among the messages transmitted through the group chatroom as illustrated in the screen 602 of FIG. 6B. The number of reactions to a message may be displayed through a reaction display window 622 corresponding to the message. When reactions to the message are received from participants of the group chatroom, the number of the received reactions may be displayed by each type through the reaction display window 622.

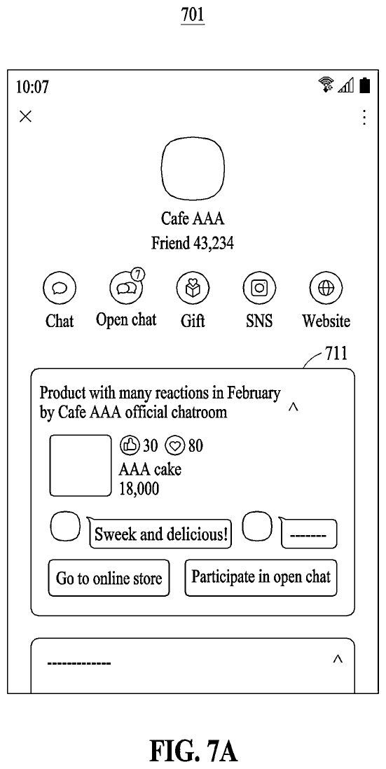

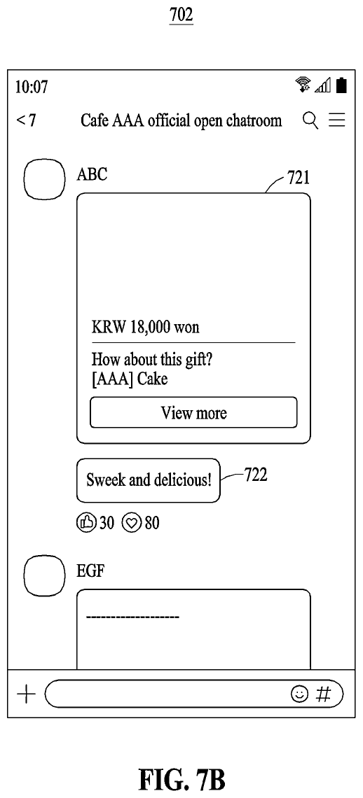

For example, a screen 701 of FIG. 7A may be a screen of the terminal displaying the page of the channel. Referring to the screen 701 of FIG. 7A, the page of the channel may include content 711 corresponding to the messages transmitted through the group chatroom. The content 711 may include content corresponding to a message including information on a product corresponding to the channel among the messages transmitted through the group chatroom. For example, as illustrated in a screen 702 of FIG. 7B, the content 711 may include a message 721 including a purchase link for the product corresponding to the channel and a relevant message 722 written related to the message 721 among the messages transmitted through the group chatroom. The relevant message 722 written related to the message 721 may include at least one of a message written together with the message 721, a message written right after the message 721, a message written as a reply to the message 721, and a message including information on the message 721.

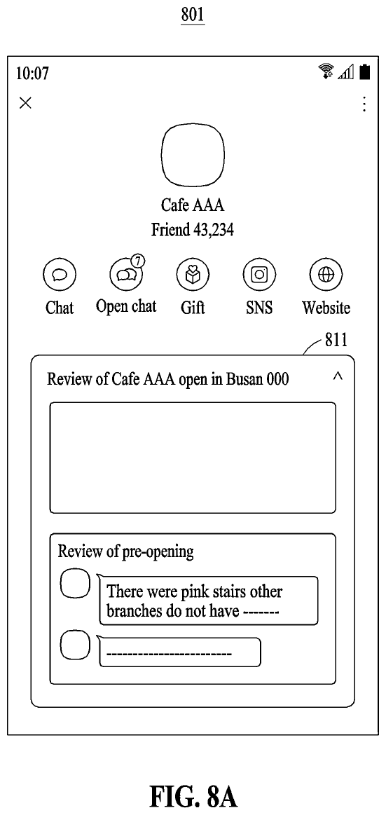

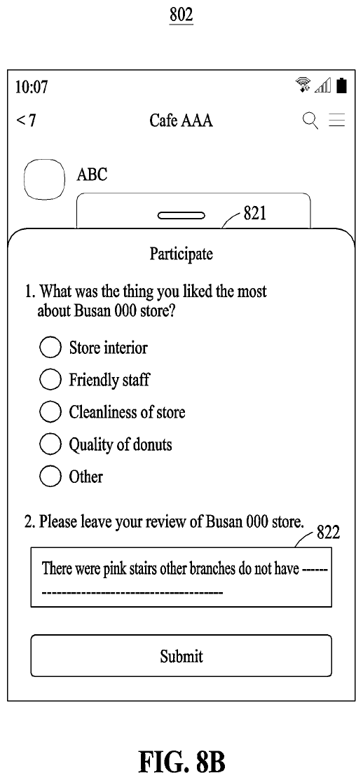

For example, a screen 801 of FIG. 8A may be a screen of the terminal displaying the page of the channel. Referring to the screen 801 of FIG. 8A, the page of the channel may include content 811 corresponding to the messages transmitted through the group chatroom. The content 811 may include content corresponding to a message written corresponding to an event held through the group chatroom. For example, as illustrated in the screen 802 of FIG. 8B, a survey form 821 may be provided through the group chatroom to the terminal of a user account participating in the group chatroom. The content 811 of the page of the channel may include a message 822 written by a participant of the group chatroom collected through the survey form 821.

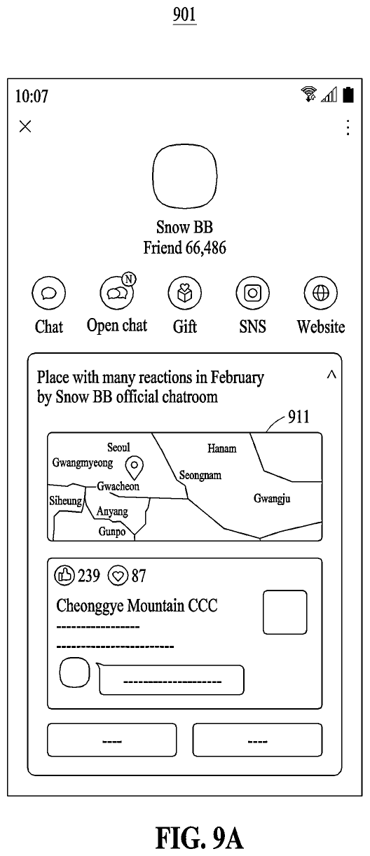

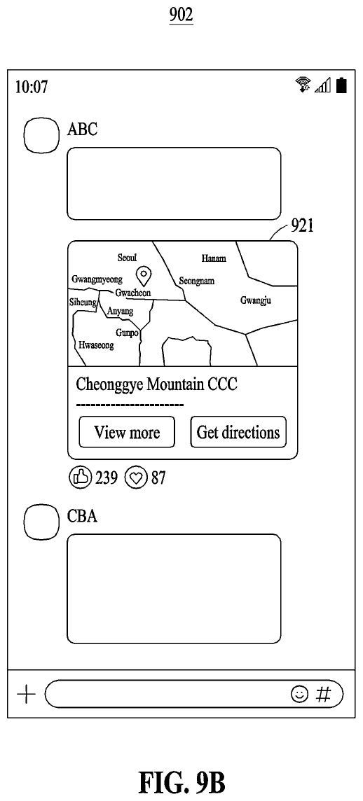

For example, a screen 901 of FIG. 9A may be a screen of the terminal displaying the page of the channel. Referring to the screen 901 of FIG. 9A, the page of the channel may include content 911 corresponding to the messages transmitted through the group chatroom. The content 911 may include content of a message including a link to a map component related to the channel among the messages transmitted through the group chatroom. For example, as illustrated in a screen 902 of FIG. 9B, the content 911 may be generated based on a message 921 including the link to the map component related to the channel among the messages transmitted through the group chatroom. The content 911 may include the map component connected through the link included in the message 921. Whether the map component connected through the link included in the message 921 is related to the channel may be determined based on the relevance between a place of the map component connected through the link and the channel, a product sold corresponding to the channel, or a service provided corresponding to the channel.

Referring to FIG. 4 again, the operating method of the terminal, according to an embodiment, may include operation 430 of displaying a page of the group chatroom based on approval of the request.

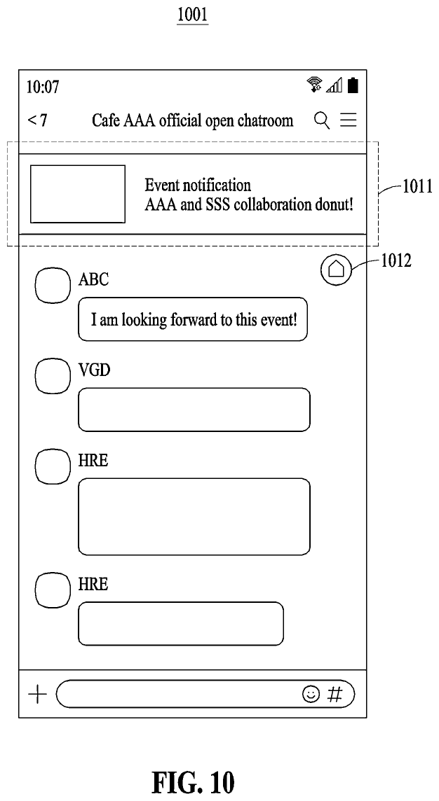

For example, FIG. 10 is an example of a screen of the terminal displaying a page of a group chatroom. Referring to a screen 1001 of FIG. 10, the page of the group chatroom linked to the channel on the terminal of which a request for participation in the group chatroom is approved. The page of the group chatroom may include a chat window displaying a list of messages transmitted through the group chatroom. The page of the group chatroom may display a list of participants in the group chatroom. The page of the group chatroom may include a chat input box to input and send a chat message.

The page of the group chatroom may include an interfacing object 1012 to request a page of the channel linked to the group chatroom. The interfacing object 1012 may be an example of an access point connecting to the page of the channel. Through an input of selecting the interfacing object 1012, the terminal may request the page of the channel from the server and the screen 1001 of the terminal may be switched to a screen displaying the page of the channel.

The page of the group chatroom may include an area 1011 providing information on the channel. The area 1011 may display at least some of the information included on the page of the channel. For example, content corresponding to the event information 521 related to the channel included in the screen 502 of FIG. 5B may be posted in the area 1011. The information or content included in the area 1011 may vary depending on the information or content included on the page of the channel.

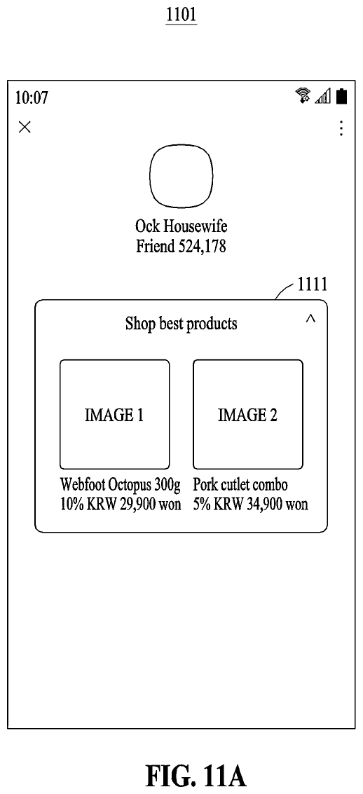

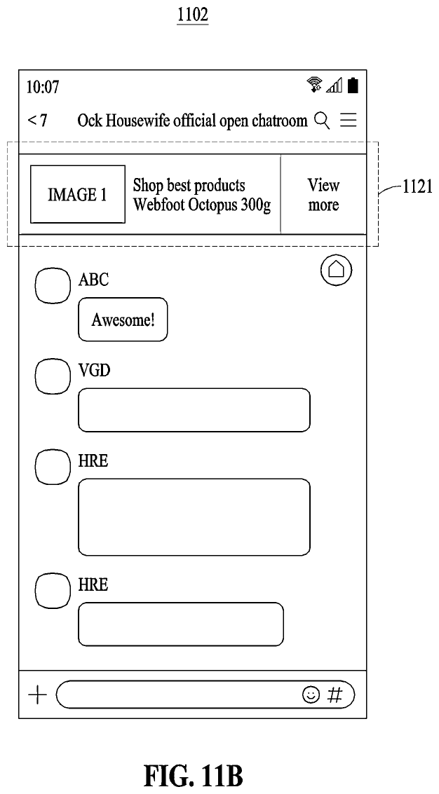

For example, referring to a screen 1101 of FIG. 11A, information 1111 on a product corresponding to the channel may be provided through the page of the channel. The information 1111 on the product may include a link connected to a service page selling the product. Referring to a screen 1102 of FIG. 11B, content 1121 corresponding to the information 1111 on the product provided through the page of the channel may be posted on the page of the group chatroom. The content 1121 may include information on the product sold corresponding to the channel included in the information 1111 on the product and the link connected to the service page selling the product included in the information 1111 on the product.

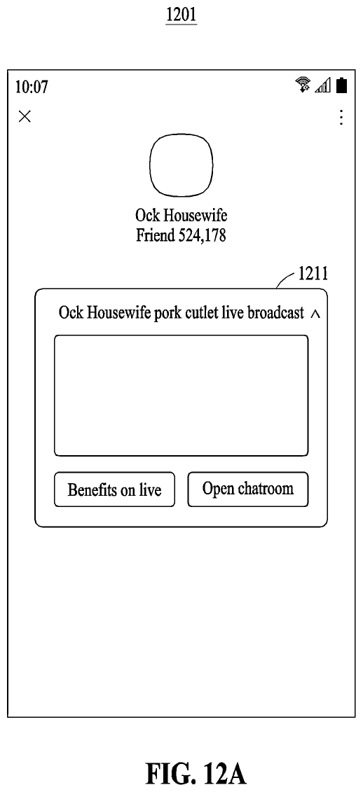

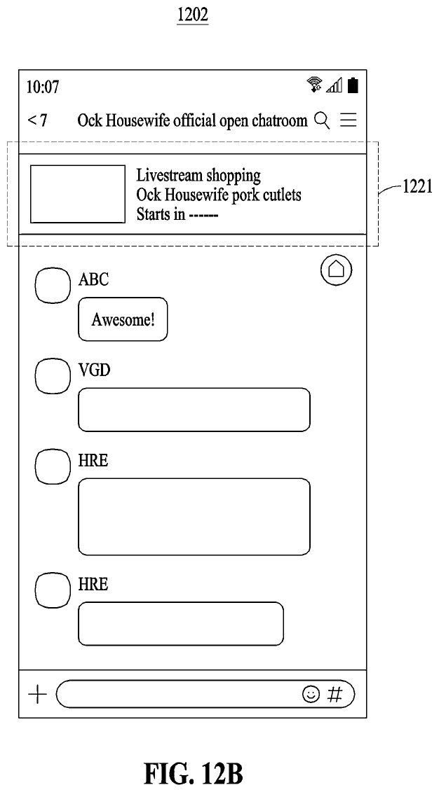

For example, referring to a screen 1201 of FIG. 12A, information 1211 on a service page corresponding to the channel may be provided through the page of the channel. The service page may include, for example, a page where a live broadcast of a product sold corresponding to the channel is uploaded. The information 1211 on the service page may include content (e.g., video) posted on the service page. The information 1211 on the service page may include a link connected to the content posted on the service page. Referring to a screen 1202 of FIG. 12B, content 1221 corresponding to the information 1211 on the service page provided through the page of the channel may be posted on the page of the group chatroom. The content 1221 may include summary information (e.g., a thumbnail of the video, a live broadcast date and time, or the information of a product sold through the live broadcast) on the content (e.g., the video) included in the information 1211 on the product. The content 1221 may include the link connected to the content posted on the service page included in the information 1211 on the product.

According to an embodiment, when a participation condition is not set for the group chatroom linked to the channel, the server may approve the request, received from the terminal of a user account, for participation in the group chatroom. Meanwhile, when the participation condition is set for the group chatroom linked to the channel, the server may not approve the request, received from the terminal of a user account, for participation in the group chatroom according to the result of determining the participation condition of the user account.

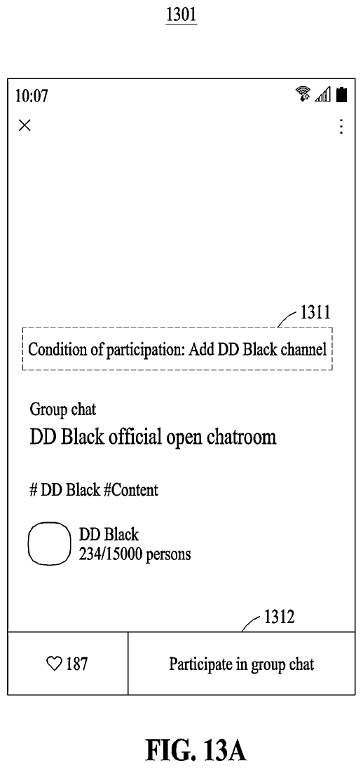

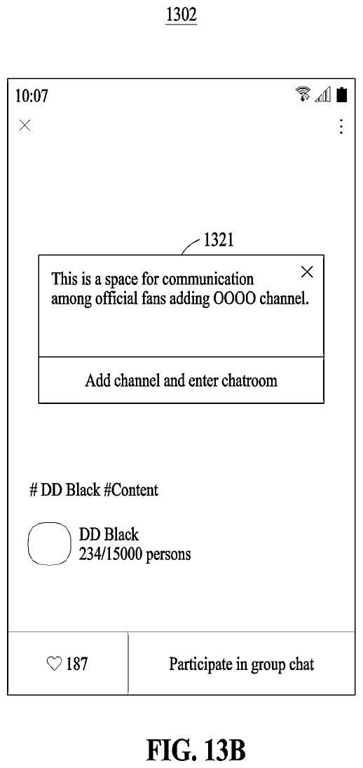

For example, referring to a screen 1301 of FIG. 13A, a main page of the group chatroom may be displayed through an access point including the access path to the group chatroom. The main page of the group chatroom may include information (e.g., the name, introduction, tag, theme, participant information, opening date of the chatroom) on the group chatroom. The main page of the group chatroom may include information 1311 on a participation condition set for the group chatroom. The information 1311 on a participation condition set for the group chatroom may indicate a condition of registering (or adding) the channel linked to the group chatroom as a certain relationship. The main page of the group chatroom may include an interfacing object 1312 to request participation in the group chatroom. Through an input of selecting the interfacing object 1312, the terminal may request participation in the group chatroom from the server.

When receiving the request for participation in the group chatroom by a user account, the server may determine whether the user account satisfies the participation condition set for the group chatroom. If the user account requesting participation in the group chatroom has registered the channel linked to the group chatroom as a certain relationship, the request, received from the terminal, for participation in the group chatroom may be approved. The page of the group chatroom may be provided to the terminal of the user account for which the participation request is approved.

If the user account requesting participation in the group chatroom has not registered the channel linked to the group chatroom as a certain relationship, the request, received from the terminal, for participation in the group chatroom may not be approved. An interfacing object 1321 to request a participation condition may be provided to the terminal of a user account as illustrated in a screen 1302 of FIG. 13B. Through an input of selecting the interfacing object 1321, a page to register the channel linked to the group chatroom may be provided to the terminal. If the user account satisfies the participation condition, the page of the group chatroom may be provided to the terminal of the user account.

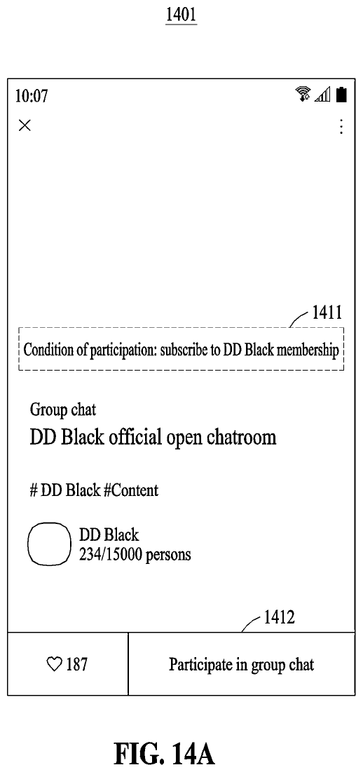

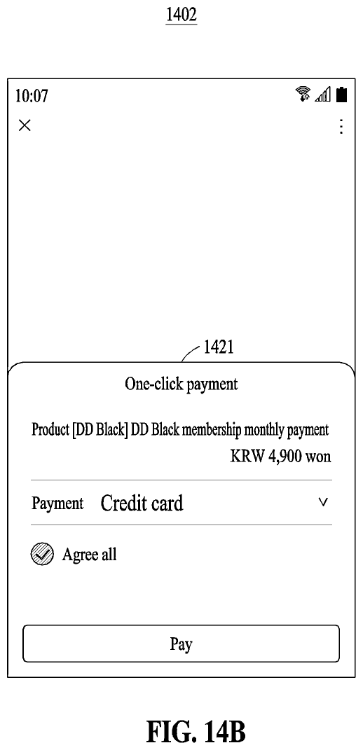

For example, referring to a screen 1401 of FIG. 14A, the main page of the group chatroom may be displayed through the access point including the access path to the group chatroom. The main page of the group chatroom may include information 1411 on a participation condition set for the group chatroom. The information 1411 on a participation condition may indicate a condition of signing up for a membership corresponding to the channel. The main page of the group chatroom may include an interfacing object 1412 to request participation in the group chatroom. Through an input of selecting the interfacing object 1412, the terminal may request participation in the group chatroom from the server.

When receiving the request for participation in the group chatroom by a user account, the server may determine whether the user account satisfies the participation condition set for the group chatroom. If the user account requesting participation in the group chatroom has signed up for the membership corresponding to the channel, the request, received from the terminal, for participation in the group chatroom may be approved. The page of the group chatroom may be provided to the terminal of the user account for which the participation request is approved.

If the user account requesting participation in the group chatroom has not signed up for the membership corresponding to the channel, the request, received from the terminal, for participation in the group chatroom may not be approved. An interfacing object 1421 to request a participation condition may be provided to the terminal of a user account as illustrated in a screen 1402 of FIG. 14B. Through an input of selecting the interfacing object 1421, a page to register the channel linked to the group chatroom may be provided to the terminal. If the user account satisfies the participation condition, the page of the group chatroom may be provided to the terminal of the user account.

Referring to FIG. 4 again, operation 430 of displaying the page of the group chatroom may include an operation of outputting an advertising material corresponding to the channel through the page of the group chatroom and an operation of executing an action corresponding to the advertising material. As described above, depending on user groups, different advertisements may be provided through the group chatroom.

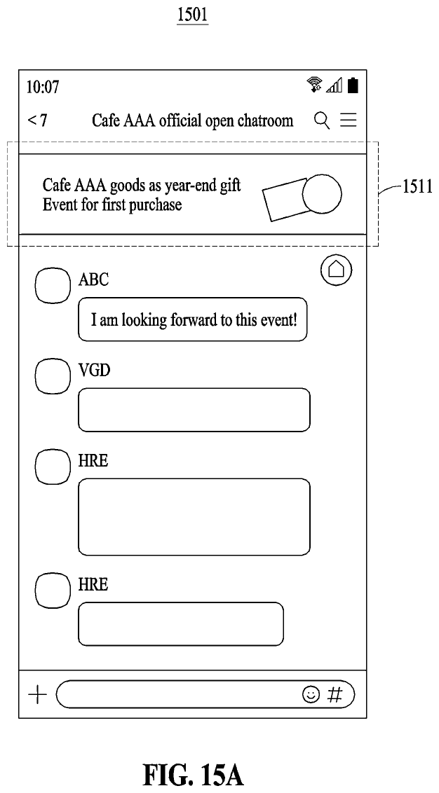

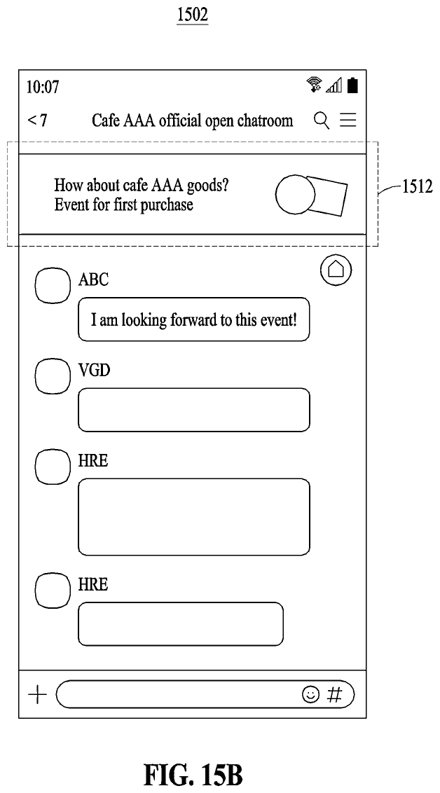

For example, a screen 1501 of FIG. 15A may be a page of a group chatroom provided to the terminal of a user account corresponding to a first user group, and a screen 1502 of FIG. 15B may be a page of a group chatroom provided to the terminal of a user account corresponding to a second user group. A first advertising material may be displayed in an area 1511 corresponding to an advertising channel included in the screen 1501 of FIG. 15A, and a second advertising material may be displayed in an area 1521 corresponding to an advertising channel included in the screen 1502 of FIG. 15B. The first advertising material displayed in the area 1511 and the second advertising material displayed in the area 1521 may have the same advertising target but different texts and images. An action corresponding to an advertisement executed in the terminal may include at least one of an input of selecting the area 1511 or the area 1521, an action of purchasing the advertisement target of the advertisement output through the area 1511 or the area 1521, and an action of visiting a page selling the advertisement target. As described above, an action executed corresponding to an advertising material may be evaluated as the advertisement performance of the advertising material. Depending on the advertisement performance of an advertising material, the advertising material to be provided through the second advertising channel linked to the server, not the page of the group chatroom, may be determined.

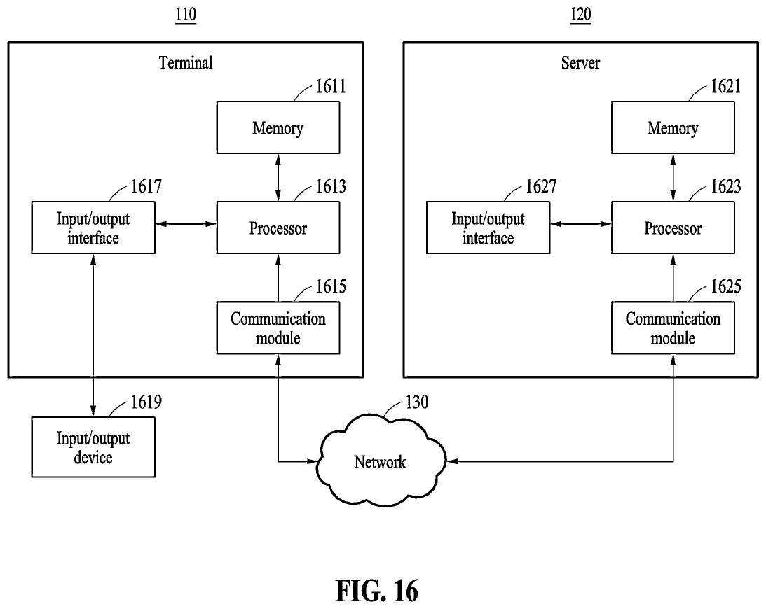

FIG. 16 is another diagram illustrating a hardware configuration of a system for the instant messaging service according to an embodiment.

Referring to FIG. 16, the system (e.g., the system 100 of FIG. 1), according to an embodiment, may include the terminal 110 and the server 120 connected through the network 130.

The terminal 110 may be a mobile terminal implemented as a computer device. For example, the terminal 110 may communicate with the server 120 and/or other electronic devices through the network 130 by using a wired or wireless communication method.

The server 120 may be implemented as one or more computer devices providing commands, code, files, content, services, and the like by communicating with the terminal 110 and/or another server through the network 130. A communication method may not be limited and may include a communication method using a communication network (e.g., a mobile communication network, wired Internet, wireless Internet, and a broadcasting network) that may be included in the network 130 and a short-distance wireless communication method between devices. For example, the network 130 may include one or more networks among networks, such as a personal area network (PAN), a local area network (LAN), a campus area network (CAN), a metropolitan area network (MAN), a wide area network (WAN), a broadband network (BBN), the Internet, and the like.

According to an embodiment, the server 120 may provide a file for installing an application to the terminal 110 accessing the server 120 through the network 130. In this case, the terminal 110 may install the application (e.g., an instant messenger) by using the file provided by the server 120. In addition, by control of an operating system (OS) and at least one program (e.g., a browser or an installed application) that are included by the terminal 110, the terminal 110 may access the server 120 and receive a service or content provided by the server 120. For example, when the terminal 110 transmits a service request message to the server 120 through the network 130 by control of the application, the server 120 may transmit code corresponding to the service request message to the terminal 110 and the terminal 110 may provide a user with content by composing and displaying a screen according to the code.

According to an embodiment, the terminal 110 and the server 120 may respectively include memories 1611 and 1621, processors 1613 and 1623, communication modules 1615 and 1625, and input/output interfaces 1617 and 1627.

The processors 1613 and 1623 may perform at least one operation described above with reference to FIGS. 1 to 15B. For example, the processor 1613 may perform at least one operation of the server providing the instant messaging service described above with reference to FIGS. 2 and 3, and the processor 1623 may perform at least one operation of the terminal using the instant messaging service described above with reference to FIG. 4. The processors 1613 and 1623 may be configured to process commands of a computer program by performing basic arithmetic, logic, and an input/output operation. The commands may be provided to the processors 1613 and 1623 by the memories 1611 and 1621 or the communication modules 1615 and 1625.

The memories 1611 and 1621 may be a computer-readable storage medium, which may be volatile or non-volatile memory. The memories 1611 and 1621, according to an embodiment, may store information to implement the driving of an instant messenger for the instant messaging service described above with reference to FIGS. 1 to 15B. For example, the memory 1621 may store the information of user accounts having subscribed to the instant messaging service and the information of chatrooms.

The memory 1611 may include code for the instant messenger that is installed to be driven in the terminal by files provided by the server 120 through the network 130.

The memory 1621 may store a program implementing operations for the instant messaging service described above with reference to FIGS. 1 to 15B.

The communication modules 1615 and 1625 may provide a function for the terminal 110 and the server 120 to communicate with each other through the network 130 and a function for the terminal 110 and the server 120 to communicate with another electronic device or another server through the network 130.

For example, a request generated by the processor 1613 of the terminal 110 according to program code on an instant messenger stored in a storage medium, such as the memory 1611, may be transmitted to the server 120 through the network 130 by control of the communication module 1615.

For example, control signals, commands, content, files, and the like provided by control of the processor 1623 of the server 120 may be received by the terminal 110 through the communication module 1615 of the terminal 110 after passing through the communication module 1625 and the network 130.

The input/output interfaces 1617 and 1627 may be a tool for interfacing with an input/output device 1619. For example, an input device may include a device, such as a keyboard or a mouse, and an output device may include a device, such as a display for displaying a communication session of an application. In another example, the input/output interface 1617 may be an interface with a device having input and output functions, such as a touch screen. Specifically, for example, when the processor 1613 of the terminal 110 processes commands of a computer program loaded in the memory 1611, content or a service screen configured by using data provided by the server 120 may be displayed on a display through the input/output interface 1617. An input received from the user through the input/output device 1619 may be provided in a processable form in the processor 1613 of the terminal 110 through the input/output interface 1617.

According to an embodiment, the terminal 110 and the server 120 may further include other components that are not illustrated in FIG. 16. For example, the terminal 110 may be implemented to include at least a part of the input/output device 1619 described above or may further include other components, such as transceivers, global positioning system (GPS) modules, cameras, various types of sensors, databases, and the like.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an OS and one or more software applications that run on the OS. The processing unit also may access, store, manipulate, process, and generate data in response to execution of the software. For purpose of simplicity, the description of a processing unit is used as singular; however, one skilled in the art will appreciate that a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or collectively instruct or configure the processing unit to operate as desired. Software and data may be stored in any type of machine, component, physical or virtual equipment, or computer storage medium or device capable of providing instructions or data to or being interpreted by the processing unit. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random-access memory (RAM), flash memory, and the like. Examples of program instructions include both machine code, such as produced by a compiler, and files containing higher-level code that may be executed by the computer using an interpreter.

The above-described devices may act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An operating method of a server providing an instant messaging service, the operating method comprising:
generating an access path to a group chatroom linked to a channel;
providing an access point to the group chatroom through a page of the channel based on the access path;
providing information on the channel through the group chatroom; and
posting content based on a message transmitted through the group chatroom on the page of the channel.

2. The operating method of claim 1, wherein the providing the information on the channel through the group chatroom comprises:
posting content linked to the information on the channel, provided through the page of the channel, in the group chatroom.

3. The operating method of claim 1, wherein the posting the information on the channel in the group chatroom comprises at least one of:
transmitting a message comprising the information on the channel through the group chatroom; and
posting content corresponding to the information on the channel in a predetermined area in the group chatroom.

4. The operating method of claim 1, wherein the posting the content on the page of the channel comprises:
generating content corresponding to the message based on relevance between the message transmitted through the group chatroom and the channel; and
posting the generated content on the page of the channel.

5. The operating method of claim 1, further comprising:
determining a participation condition of a user account having requested participation in the group chatroom through the access point based on a participation condition set for the group chatroom; and
comprising the user account as a participant in the group chatroom based on a result of determining the participation condition.

6. The operating method of claim 1, further comprising providing an access point to the channel through the group chatroom.

7. An operating method of a server providing an instant messaging service, the operating method comprising:
providing a first advertising material to a terminal of a first user group through a first advertising channel comprised in a group chatroom linked to a channel;
providing a second advertising material to a terminal of a second user group through the first advertising channel; and
determining an advertising material to be provided through a second advertising channel linked to the server based on advertisement performance corresponding to the first advertising material and advertisement performance corresponding to the second advertising material.

8. The operating method of claim 7, wherein the determining the advertising material to be provided through the second advertising channel comprises:
determining an advertising material determined to have higher advertisement performance between the first advertising material and the second advertising material as the advertising material to be provided through the second advertising channel.

9. The operating method of claim 7, wherein the advertisement performance corresponding to the first advertising material and the advertisement performance corresponding to the second advertising material are determined based on an a/b test corresponding to the first advertising material and the second advertising material.

10. The operating method of claim 7, wherein an advertisement type corresponding to the first advertising channel is the same as an advertisement type corresponding to the second advertising channel.

11. An operating method of a terminal using an instant messaging service, the operating method comprising:
displaying information on a group chatroom linked to a channel through a page of the channel;
requesting participation in the group chatroom based on the information on the group chatroom; and
displaying a page of the group chatroom based on approval of the request.

12. The operating method of claim 11, wherein displaying the page of the group chatroom comprises:
outputting an advertising material corresponding to the channel through the page of the group chatroom; and
executing an action corresponding to the advertising material.

13. A non-transitory computer-readable storage medium storing instructions that, when executed by one or more processors, cause the one or more processors to perform the operating method of claim 1.

14. A server providing an instant messaging service, the server comprising one or more processors configured to:
generate an access path to a group chatroom linked to a channel,
provide an access point to the group chatroom through a page of the channel based on the access path,
provide information on the channel through the group chatroom, and
post content based on a message transmitted through the group chatroom on the page of the channel.

15. The server of claim 14, wherein the one or more processors is further configured to:
provide information on the channel through the group chatroom, and
post content linked to the information on the channel, provided through the page of the channel, in the group chatroom.

16. The server of claim 14, wherein the one or more processors is further configured to:
provide information on the channel through the group chatroom, and
transmit a message comprising the information on the channel through the group chatroom, and
post content corresponding to the information on the channel in a predetermined area in the group chatroom.

17. The server of claim 14, wherein the one or more processors is further configured to, when posting the content on the page of the channel,
generate content corresponding to the message based on relevance between the message transmitted through the group chatroom and the channel, and
post the generated content on the page of the channel.

18. The server of claim 14, wherein the one or more processors is further configured to:
determine a participation condition of a user account having requested participation in the group chatroom through the access point based on a participation condition set for the group chatroom, and
comprise the user account as a participant in the group chatroom based on a result of determining the participation condition.

19. A server providing an instant messaging service, the server comprising one or more processors configured to:
provide a first advertising material to a terminal of a first user group through a first advertising channel comprised in a group chatroom linked to a channel,
provide a second advertising material to a terminal of a second user group through the first advertising channel, and
determine an advertising material to be provided through a second advertising channel linked to the server based on advertisement performance corresponding to the first advertising material and advertisement performance corresponding to the second advertising material.

20. A terminal using an instant messaging service, the terminal comprising:
one or more processors configured to:
display information on a group chatroom linked to a channel through a page of the channel,
request participation in the group chatroom based on the information on the group chatroom, and
display a page of the group chatroom based on approval of the request.
